(19) United States
(12) Patent Application Publication
(10) Pub. No.: US 2010/0154839 A1
(43) Pub. Date: Jun. 24, 2010

(54) Paint accessory cleaning apparatus

(76) Inventor: Richard Dale Brunson, Byron Center, MI (US)

Correspondence Address: King & Partners, PLC, 170 College Avenue, SUITE 230, HOLLAND, MI, 49423, US

(21) Appl. No.: 12/317,628

(22) Filed: Dec. 24, 2008

(51) Int. Cl. B08B 3/06; B08B 1/00

(52) U.S. Cl. 134/38; 15/104.92; 134/104.3

(57) ABSTRACT

A paint accessory cleaning apparatus including: an outer container adapted to contain a cleaning agent, wherein the outer container includes an inner surface; and an outer surface; an inner container adapted to contain a cleaning agent and at least one paint accessory, wherein the inner container includes an inner surface; an outer surface, and at least one aperture, wherein the at least one aperture is configured to allow the communication of a cleaning agent therethrough, and wherein the inner container is associable with the outer container; at least one paint accessory associated with the inner surface of the inner container; and a cleaning agent, wherein the cleaning agent is associated with the inner surface of the outer container, the inner surface of the inner container, and the at least one paint accessory.

### CROSS-REFERENCE TO RELATED APPLICATION(S)

Not Applicable

### BACKGROUND OF THE INVENTION

1. Field of the Invention

The present invention relates in general to a paint accessory cleaning apparatus and, more particularly, to a paint accessory cleaning apparatus which allows a user to clean and/or remove paints and/or other chemicals from a variety of painting accessories (e.g. sprayer tips, nozzles, etc).

2. Background Art

Paint sprayers have been known in the art for years. While conventional paint sprayers have been known in the art for years, issues relative to post use cleaning and/or maintenance remain largely problematic. In particular, paint sprayers typically utilize a variety of mechanical parts associated with the sprayer body and a variety of accessories that are associated with the sprayer body to disperse and/or direct paints and/or other chemicals. The parts and accessories are typically cleaned by placing the same in a container and allowing them to soak in a cleansing agent. Other methods for cleansing these types of parts and accessories include simply pouring the cleansing agent over the parts. Unless gloves are worn when cleansing the parts and/or accessories, a user's hands are typically exposed to extremely hazardous chemicals—including carcinogens. It is therefore an object of the present invention, to provide a cleaning apparatus which, among other things, remedies the aforementioned detriments and/or complications associated with the use of conventional, cleaning devices and methods.

These and other objects of the present invention will become apparent in light of the present specification, claims, and drawings.

### SUMMARY OF THE INVENTION

The present invention is directed to a paint accessory cleaning apparatus comprising: (a) an outer container adapted to contain a cleansing agent, wherein the outer container comprises: (1) an inner surface; and (2) an outer surface; (b) an inner container adapted to contain a cleansing agent and at least one paint accessory, wherein the inner container comprises: (1) an inner surface; (2) an outer surface; and (3) at least one aperture, wherein the at least one aperture is configured to allow the communication of a cleansing agent therethrough, and wherein the inner container is associable with the outer container; (c) at least one paint accessory associated with the inner surface of the inner container; and (d) a cleansing agent, wherein the cleansing agent is associated with the inner surface of the outer container, the inner surface of the inner container, and the at least one paint accessory.

In a preferred embodiment of the present invention, the inner container comprises a bottom surface, wherein the bottom surface comprises a mesh strainer for communicating a cleansing agent therethrough.

In another preferred embodiment of the present invention, the inner container comprises at least one flange, wherein the at least one flange extends from the outer surface of the inner container.

In yet another preferred embodiment of the present invention, the at least one flange extends radially from the outer surface of the inner container.

In one aspect of the present invention, the at least one flange extends longitudinally from the outer surface of the inner container.

In a preferred embodiment of the present invention, the at least one flange contacts at least a portion of the inner surface of the outer container when the inner container is received within the outer container.

In another preferred embodiment of the present invention, the at least one flange comprises an outer edge, wherein the outer edge contacts at least a portion of the inner surface of the outer container when the inner container is received within the outer container.

In yet another preferred embodiment of the present invention, the outer edge of the at least one flange comprises a non-stick coating.

In one aspect of the present invention, the inner surface of the outer container, the inner surface of the inner container and the outer edge of the at least one flange comprise a non-stick coating.

In one embodiment of the present invention, the inner container comprises a plurality of flanges and/or a plurality of apertures.

The present invention is also directed to a method for cleaning painting accessories, comprising the steps of: (a) providing a paint accessory cleaning apparatus as disclosed herein; (b) introducing painting accessories into the inner container of the cleaning apparatus; (c) introducing a cleansing agent into the cleaning apparatus; (d) leaving the painting accessories in the cleansing agent for a period of time; and (e) removing the inner container from the outer container.

In a preferred embodiment of the present invention, the method for cleaning painting accessories further comprises the step of agitating the painting accessories before removing the inner container from the outer container.

In another preferred embodiment of the present invention, the method for cleaning painting accessories includes substantially covering the painting accessories with a cleansing agent.

In yet another preferred embodiment of the present invention, the method for cleaning painting accessories further comprises the step of rinsing the painting accessories.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be understood that the invention is not necessarily limited to the particular embodiments illustrated herein.

The invention will now be described with reference to the drawings wherein:

FIG. 1A of the drawings is an exploded perspective view of a paint accessory cleaning apparatus fabricated in accordance with the present invention;

FIG. 1B of the drawings is a cross sectional view of a paint accessory cleaning apparatus fabricated in accordance with the present invention;

FIGS. 2A-2B of the drawings are top-down views of a paint accessory cleaning apparatus fabricated in accordance with the present invention;

FIGS. 3A-3C of the drawings are perspective views of various embodiments of inner containers fabricated in accordance with the present invention; and

FIG. 4 of the drawings is a cross sectional view of a paint accessory cleaning apparatus fabricated in accordance with the present invention.

### DETAILED DESCRIPTION OF THE INVENTION

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters.

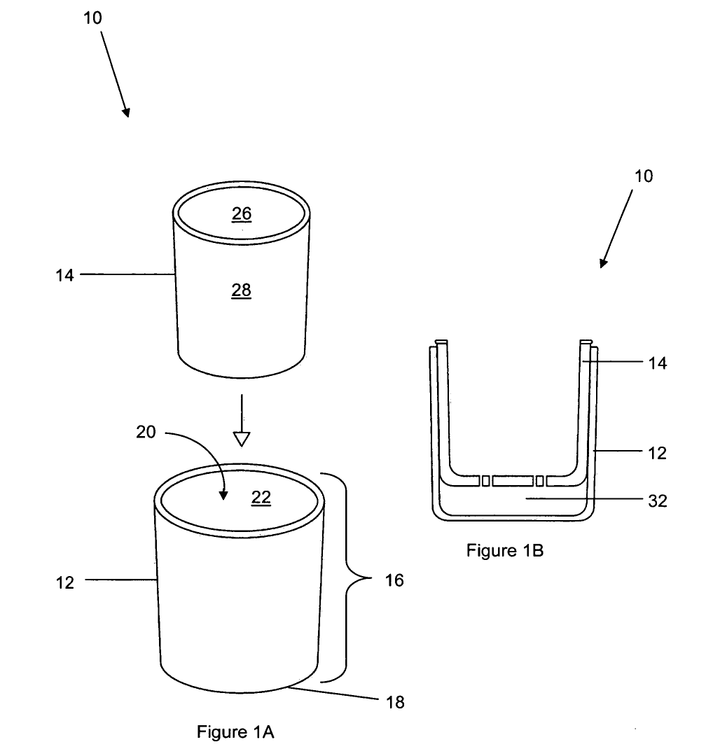

Referring now to the drawings, and to FIG. 1A in particular, an exploded view of paint accessory cleaning apparatus 10 is shown as generally comprising outer container 12 and inner container 14. It will be understood that while outer and inner containers 12 and 14, respectively, have been disclosed in FIG. 1A as comprising a generally circular cross section which forms a cylinder, numerous other geometric configurations are likewise contemplated for use in accordance with the present invention, including, substantially triangular, substantially square, substantially rectangular, substantially polygonal (i.e. 2 or more sides), substantially arbitrary, etcetera. For purposes of the present disclosure, outer container 12 and inner container 14 are preferably fabricated from a material selected from the group comprising metals including steel, aluminum, and metallic alloys, woods, as well as natural and/or synthetic plastics and/or resins, and mixtures thereof. It will be understood that natural and/or synthetic plastics and/or resins are more preferred than other materials due to, among other things, strength, durability, cost, and manufacturing ease and/or flexibility, although any one of a number of materials that would be known to one of ordinary skill in the art having the present disclosure before them are likewise contemplated for use in accordance with the present invention.

In one embodiment of the present invention, outer container 12 is preferably cylindrical 16 and includes base/bottom member 18. It will be understood that cylinder 16 and base member 18 preferably comprise a unitary member and cooperate to define containment area 20. As will be discussed in greater detail infra, containment area 20 is configured to receive both inner container 14 and/or a cleaning agent. Outer container 12 also preferably comprises inner surface 22. It will be understood that inner surface 22 preferably substantially conforms to the area (i.e. circumference x length—for a cylinder) of containment area 20.

Referring collectively now to FIGS. 1A and 1B, a plurality of views of paint accessory cleaning apparatus 10 are shown. In accordance with the present disclosure, inner container 14 preferably comprises inner surface 26 and outer surface 28. To cooperate with outer container 12, the outer diameter of at least a portion of inner container 14 is preferably smaller than at least a portion of the inner diameter of outer container 12. This difference in diameters allows the inner container 14 to be at least partially positioned within containment area 20. In one embodiment, both outer container 12 and inner container 14 comprise the same substantially circular cross section and also comprise generally different lengths, such that when inner container 14 is placed into outer container 12, they cooperate to define cavity 32.

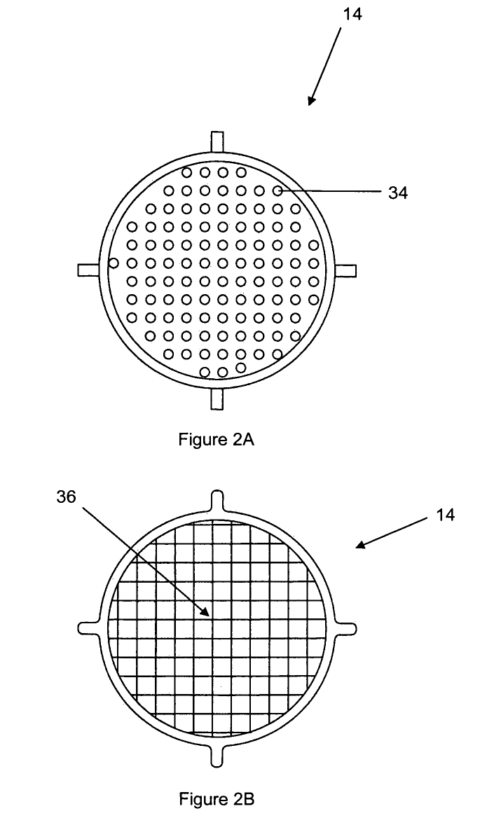

Referring now to FIG. 2A, a top down view of inner container 14 is shown. In accordance with the present disclosure, inner container 14 preferably comprises at least one aperture 34. It will be understood that while is shown as comprising a substantially circular cross section, any one of a number of geometrical cross sections are likewise contemplated for use in accordance with the present invention. As will be discussed in greater detail infra, aperture 34 operates to communicate a cleaning agent therethrough.

Referring now to FIG. 2B, a top down view of inner container 14 is shown. In this particular embodiment, inner container 14 is shown as comprising generally perpendicularly positioned mesh. Mesh 36 likewise operates to communicate a cleaning agent therethrough, while removing solid materials of varying size from the cleaning agent.

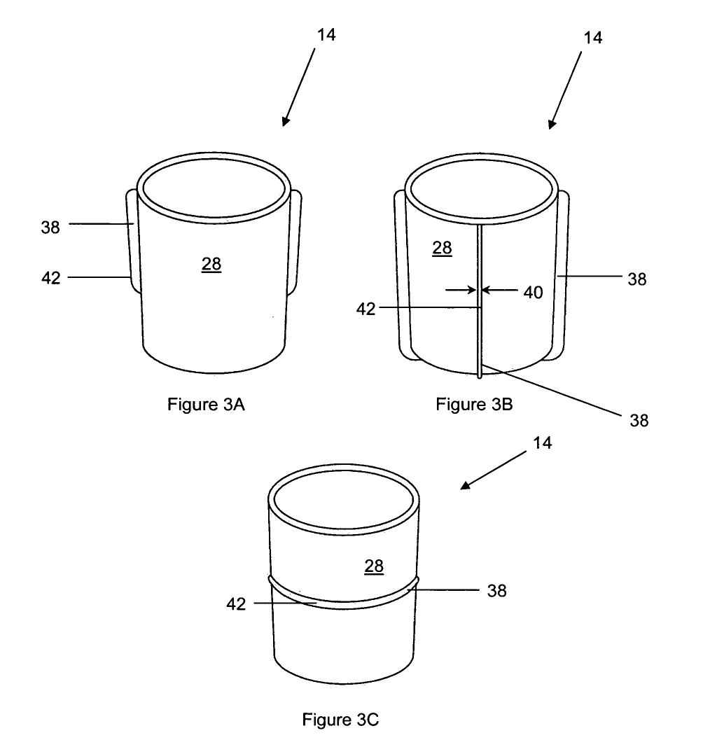

Referring now to FIGS. 3A-3C collectively, multiple perspective views of a plurality of embodiments of inner container 14 are shown. To reduce the propensity of inner container 14 from sticking, jamming, fixedly mating, and/or bonding with outer container 12 (see FIG. 1A), inner container 14 may preferably comprise at least one flange 38. Sticking, jamming, fixedly mating, and/or bonding may occur when cleaning and/or soiling agents (e.g. paint, stains, etc.) operate to join inner container 14 to outer container 12, or when a vacuum forms when inner container 14 is inserted into outer container 12. Flanges 38 preferably comprise a section of material having any number of geometrical configurations. In one embodiment, flanges 38 are shown as comprising a rectangular geometrical configuration with thickness 40, and preferably extend longitudinally the entire length of outer surface 28 of inner container 14. It will be understood that flanges 38 may only extend over a portion of outer surface 28 of inner container 14. It will also be understood that flanges 28 may also extend radially around at least a portion of outer surface 28 of inner container 14.

Flanges 38 are preferably fabricated from the same materials as inner container 14, although differing materials may likewise be utilized. In one embodiment, flanges 38 preferably comprise a non-stick material (such as Teflon®, silicones, etc.) associated with the outer edge 42. This non-stick coating further enhances the flange's ability to keep outer surface 28 of inner container 14 from sticking, jamming, fixedly mating, and/or bonding with inner surface 22 of outer container 12. In another embodiment, inner container 14 preferably comprises a plurality of flanges 38.

It will be understood that although the non-stick material has been disclosed as being associated with outer edge 42 of flanges 38, a non-stick material may likewise be associated with outer surface 28 of inner container and/or inner surface 22 of outer container 12 (see FIG. 1A).

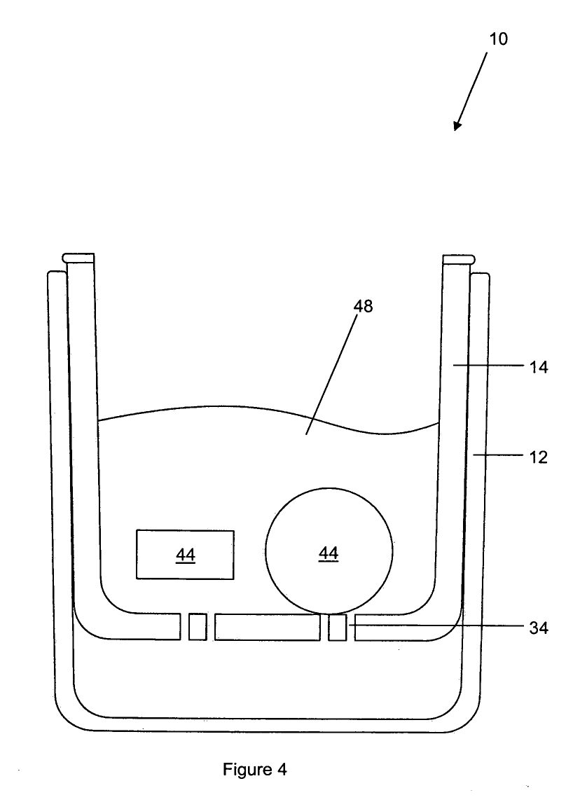

Referring now to FIG. 4, a cross sectional view of paint accessory cleaning apparatus 10 is shown. In operation, a user may place inner container 14 into outer container 12. Next, the user places one or more painting accessories (e.g. sprayer tips, sprayer parts, etc.) into inner container 14. After placing painting accessories 44 into inner container 14, a user fills cleaning apparatus 10 with cleaning agent 48 (e.g. paint thinner, paint remover, a polar solvent, a non-polar solvent, etc.). In a preferred application, the user pours in enough cleaning agent 48 to cover painting accessories 44.

Also, a user may agitate painting accessories 44 within cleaning apparatus 10. Agitation helps remove chemicals, soil, and/or filth that may otherwise be left if painting accessories 44 simply remain unagitated in cleaning apparatus 10.

Next, to remove painting accessories 44 from cleaning apparatus 10, the user preferably removes inner container 14 from outer container 12. Removing inner container 14 from outer container 12 operates to communicate (i.e. drain) cleaning agent 48 from inner container 14 into outer container 12 via apertures 34. The user may optionally rinse painting accessories 44 by pouring, for example, water, into inner container 14 having painting accessories 44.

It will be understood that the order of many of the above-identified steps may be altered and/or rearranged without departing from the scope of the present invention.

The foregoing description merely explains and illustrates the invention and the invention is not limited thereto except insofar as the appended claims are so limited, as those skilled in the art who have the disclosure before them will be able to make modifications without departing from the scope of the invention.

What is claimed:

1. A paint accessory cleaning apparatus, comprising:
an outer container adapted to contain a cleaning agent, wherein the outer container comprises:
an inner surface; and
an outer surface;
an inner container adapted to contain a cleaning agent and at least one paint accessory, wherein the inner container comprises:
an inner surface;
an outer surface; and
at least one aperture, wherein the at least one aperture is configured to allow the communication of a cleaning agent therethrough, and
wherein the inner container is associable with the outer container;
at least one paint accessory associated with the inner surface of the inner container; and
a cleaning agent, wherein the cleaning agent is associated with the inner surface of the outer container, the inner surface of the inner container, and the at least one paint accessory.

2. The paint accessory cleaning apparatus according to claim 1, wherein the inner container comprises a bottom surface, wherein the bottom surface comprises a mesh strainer for communicating a cleaning agent therethrough.

3. The paint accessory cleaning apparatus according to claim 2, wherein the inner container comprises at least one flange, wherein the at least one flange extends from the outer surface of the inner container.

4. The paint accessory cleaning apparatus according to claim 3, wherein the at least one flange extends radially from the outer surface of the inner container.

5. The paint accessory cleaning apparatus according to claim 4, wherein the at least one flange extends longitudinally from the outer surface of the inner container.

6. The paint accessory cleaning apparatus according to claim 4, wherein the at least one flange contacts at least a portion of the inner surface of the outer container when the inner container is received within the outer container.

7. The paint accessory cleaning apparatus according to claim 4, wherein the at least one flange comprises an outer edge, wherein the outer edge contacts at least a portion of the inner surface of the outer container when the inner container is received within the outer container.

8. The paint accessory cleaning apparatus according to claim 7, wherein the outer edge of the at least one flange comprises a non-stick coating.

9. The paint accessory cleaning apparatus according to claim 3, wherein inner surface of the outer container, the inner surface of the inner container and the outer edge of the at least one flange comprise a non-stick coating.

10. The paint accessory cleaning apparatus according to claim 1, wherein the inner container comprises a plurality of flanges.

11. The paint accessory cleaning apparatus according to claim 1, wherein the inner container comprises a plurality of apertures.

12. A method for cleaning painting accessories, comprising the steps of:
providing a paint accessory cleaning apparatus according to claim 1;
introducing painting accessories into the inner container of the cleaning apparatus;
introducing a cleaning agent into the cleaning apparatus;
leaving the painting accessories in the cleaning agent for a period of time; and
removing the inner container from the outer container.

13. The method for cleaning painting accessories according to claim 13, further comprising the step of agitating the painting accessories before removing the inner container from the outer container.

14. The method for cleaning painting accessories according to claim 13, wherein the cleaning agent substantially covers the painting accessories.

15. The method for cleaning painting accessories according to claim 13, further comprising the step of rinsing the painting accessories.
